(19) United States
(12) Patent Application Publication
(10) Pub. No.: US 2008/0059007 A1
(43) Pub. Date: Mar. 6, 2008

(54) SYSTEM AND METHOD FOR AUTONOMOUSLY CONVOYING VEHICLES

(76) Inventors: William L. Whittaker, Pittsburgh, PA (US); Chris Urmson, Pittsburgh, PA (US); Kevin Peterson, Pittsburgh, PA (US)

Correspondence Address: REED SMITH LLP, P.O. BOX 488, PITTSBURGH, PA, 15230-0488, US

(21) Appl. No.: 11/761,354

(22) Filed: Jun. 11, 2007

Related U.S. Application Data
(60) Provisional application No. 60/812,693, filed on Jun. 9, 2006.

(51) Int. Cl. G05D 1/00; G05D 13/00

(52) U.S. Cl. 701/2

(57) ABSTRACT

Systems, methods, and apparatuses providing for navigation of a convoy of autonomous vehicles including a lead vehicle and at least one following vehicle wherein a master which sets the free parameters of a navigation strategy may be any one of the vehicles including the following vehicles. It is possible to control the convoy of the present invention firm any position including the rear position.

### CROSS-REFERENCE TO RELATED APPLICATION

This application claims the benefit under 35 U.S.C. §119(e) of the earlier filing date of U.S. Provisional Application Ser. No. 60/812,693 filed on Jun. 9, 2006, which is hereby incorporated by reference.

### BACKGROUND OF THE INVENTION

1. Field of the Invention

The present invention relates to methods, systems, and apparatuses for vehicle convoying.

2. Description of the Background

Vehicle convoys are used in a variety of endeavors including agriculture, construction, earth moving and military operations. Military convoying is an inherently dangerous application. Implicit to the task of convoy is the danger of attack by enemy forces. Despite the dangers, convoying is a required operation that enables day-to-day military operations in war-torn regions. Convoy soldiers are exposed to extreme dangers with the threat of roadside attacks, mines and improvised explosive devices (IEDs). In a known convoy operation, a manned lead vehicle positioned at the head of a vehicle convoy is followed by unmanned follower vehicles in the convoy. The operation of the follower vehicles in this leader-follower arrangement is controlled based on information transmitted to it from the leader vehicle at the head of the convoy. The follower vehicles have no decision making capability.

Autonomous leader-follower military convoy operations are also known. To cut costs, a common practice is to endow the lead vehicle with a highly accurate pose system, then track the lead vehicle using sensor-based tracking technique such as through radar, camera, or LIDAR. This reduces cost because the follower vehicles have less expensive sensors compared to the relatively expensive inertial measurement units (IMUs) required for highly accurate pose estimation. The vehicle at the head of the convoy, however, is particularly vulnerable to hostile attacks. In the event that the lead vehicle is compromised somehow (taken over, or destroyed), the follower vehicles are helpless to take over.

In agricultural settings, sets of vehicles often operate in tandem. One vehicle may cut hay while another fluffs the freshly cut hay, and yet a third collects it. This process requires several vehicles operating in an extremely similar fashion. In known autonomous leader-follower agricultural convoy operations, one or several of the follower vehicles are autonomous, but guided by a human-driven leader vehicle at the head of the convoy. The rear vehicles then slave off the front master vehicle. In order to monitor the operation, the human watches the trailing vehicles while looking for potholes, ruts and other obstructions.

A need exists for methods, systems, and apparatuses for controlling the convoy from any position in the convoy including the rear.

### SUMMARY OF THE INVENTION

The present invention preferably encompasses systems, methods, and apparatuses that provide for navigation of a convoy of autonomous vehicles including a lead vehicle and at least one following vehicle wherein a master which sets the convoy control parameters of a navigation strategy may be any one of the vehicles including the following vehicles. It is possible to control the convoy of the present invention from any position including the rear position.

In a military setting, obfuscating the designated lead vehicle has a significant advantage. Additionally, having the ability to transfer leadership from one vehicle to another is extremely valuable.

The present invention allows a vehicle to “lead” from the rear mitigating the risk associated with a fixed leader, and easing operations such as farming. In leading from the rear, a strategy is defined that tells the each vehicle roughly which route to take.

In the case of a military convoy, this strategy is similar to finding several prioritized routes through a map from point A to point B. Nominally, the best route is followed, but in the case of emergency or blockage, the vehicles know which alternative route to take. In the case of farming, the strategy could be a coverage pattern that describes the best way to cut afl of the hay in a field.

In each case, the lead vehicle must be capable of sensing the terrain around it in order to align itself with the real world. One of the vehicles (not necessarily the lead vehicle) operates as the operations master setting the parameters of the strategy. These parameters might include the speed of the convoy or the rate of the hay bailer. As the vehicles travel they each make their own decisions about how to drive. A vehicle in a convoy might decide to pass another vehicle. A farming vehicle might decide exactly how much hay to cut at a given time or might consider how much overlap there might be between passes in a coverage pattern.

The lead vehicle has the best view of the world. In a convoy application, the lead vehicle can see the traffic ahead of the convoy. It can look ahead to see construction and people. In the farming application, the leader can see the ruts, while the follower vehicles cannot. In human-assisted operations, the human functions to add human intelligence to the operation. In the convoy application, the human might set the speed and separation. These parameters are set using sensing distinctive of humans—concern about a child running into a street in the middle of a crowded city, or suspicion of an IED hidden on the side of the road—but autonomous vehicles do not yet have the capability to use.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1; is a plan view of a convoy of autonomous vehicles according to a preferred embodiment of the present invention;

FIG. 2 depicts a block diagram of the hardware according to a preferred embodiment of the present invention; and

FIG. 3 depicts a flow chart show the operation of a preferred embodiment of the present invention.

### DETAILED DESCRIPTION OF PREFERRED EMBODIMENTS OF THE PRESENT INVENTION

It is to be understood that the figures and descriptions of the present invention have been simplified to illustrate elements that are relevant for a clear understanding of the invention, while eliminating, for purposes of clarity, other elements that may be well known. The detailed description will be provided hereinbelow with reference to the attached drawings.

Hereby fully incorporated by reference, as if set forth in their entirety herein, are the copending and commonly assigned U.S. Patent Applications filed on even date herewith entitled “System and Method for Autonomous High-Speed Navigation” and “Obstacle Detection Arrangements in and for Autonomous Vehicles”. These related applications disclose systems, arrangements and processes m the realm of autonomous vehicles that may be freely incorporable with one or more embodiments of the present invention and/or represent one or more contextual environments in which at least one embodiment of the present invention may be employed. These related applications may also readily be relied upon for a better understanding of basic technological concepts relating the embodiments of the present invention.

In the following description of embodiments of the present invention, the term “autonomous” is used to indicate operation which is completely automatic or substantially automatic, that is, without significant human involvement in the operation. An autonomous vehicle will generally be unmanned, that is without a human pilot, or co-pilot. However, an autonomous vehicle may be driven or otherwise operated automatically, and have one or more human passengers. An autonomous vehicle may be adapted to operate under human control in a non-autonomous mode of operation.

As used herein, “vehicle” refers to any self-propelled conveyance. In at least one embodiment, the description of the present invention will be undertaken with respect to vehicles that are automobiles. However the use of that exemplary vehicle and environment in the description should not be construed as limiting. Indeed, the methods, systems, and apparatuses of the present invention may be implemented in a variety of circumstances. For example, the present invention may be useful in convoying farming equipment, earth moving equipment, seaborne vehicles, and other vehicles that need to autonomously generate a path to navigate an environment.

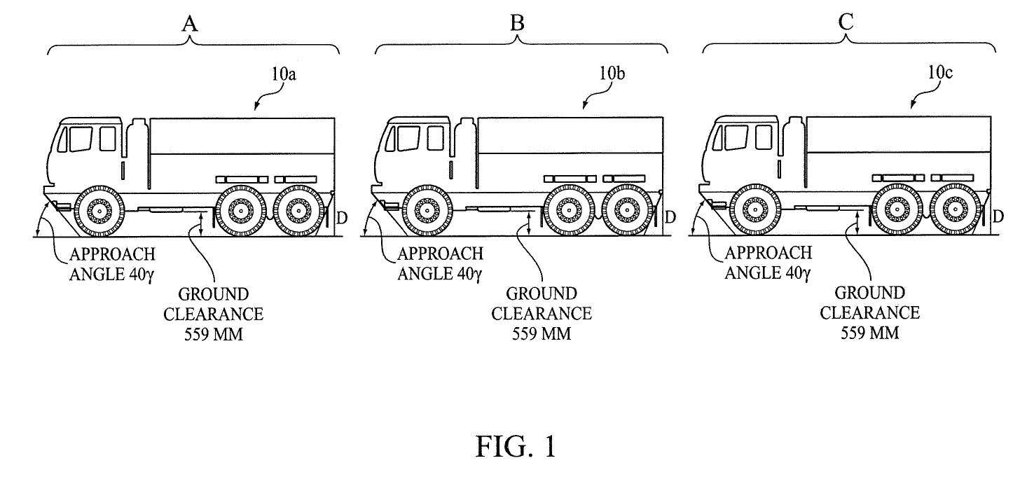

In accordance with a preferred embodiment of the present invention, FIG. 1 shows three vehicles 10a, 10b, 10c traveling in a convoy. As used herein, “convoy” refers to two or more vehicles traveling together. The number of vehicles in this embodiment is purely for illustrative purposes and could be two or more as would be appreciated by one of skill in the art. The spacing of the vehicles in FIG. 1 is for illustration purposes only and is not intended to represent a preferred spacing of vehicles. In this embodiment, vehicles 10a, 10b, 10c are identical autonomous vehicles that are adapted for both autonomous and human control. Vehicles 10a, 10b, 10c are military cargo trucks. Each vehicle 10a, 10b, 10c is equipped with at least a steering system 12, a propulsion/transmission system 16 and a braking system 18 as would be found in an automobile or truck. As shown in FIG. 1, 10a is in the lead or head position A of the convoy. Vehicle 10b is in a following position B of the convoy. Vehicle 10c is in a following/rear position C of the convoy. As used herein, “lead” or “leader” refers to the vehicle at the head, first or lead position in the convoy queue. “Follower” refers to any of the one or more vehicles positioned after the lead vehicle at any of the positions other than the first position in the convoy queue and, therefore “following” the lead vehicle. Any of the vehicles 10a, 10b, 10c is adapted for operation as a lead or follower vehicle.

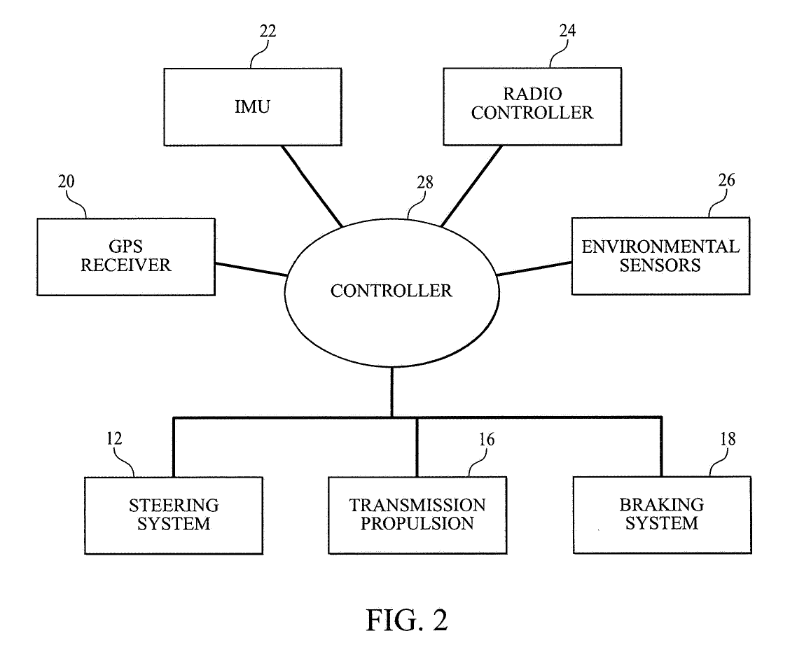

As shown in FIG. 2, each vehicle 10a, 10b, 10c is equipped with a global positioning satellite (GPS) receiver 20. The GPS receiver 20 receives vehicle position information from satellites orbiting the Earth. Each vehicle may also be equipped with an inertial measurement unit (IMU) 22 including accelerometers and gyroscopes for sensing the attitude and speed of the vehicle. Those skilled in the art will recognize that alternative ways to estimate the pose of a vehicle may be used. Each vehicle 10a, 10b, 10c is further equipped with a communicator allowing for the communication of information between vehicles. The communicators are preferably radio communicators 24 such as 900 MHz based serial radios.

Accurate autonomous navigation requires the ability to evaluate terrain and identify obstacles. Each vehicle 10a, 10b, 10c, therefore, is further equipped with environmental sensors 26 in order to evaluate terrain and sense potential obstacles. In this embodiment, each vehicle has a radar scanner mounted on its body. In presently preferred embodiments, environmental sensors are used to evaluate the terrain through which the autonomous vehicles are about to travel in order to identify terrain variations, obstacles, road deviations, or any other significant environmental factors that could impact the stability of the autonomous vehicle. The environmental sensors are also used to provide a measure of vehicle separation. Those of skill in the art will recognize that there are multiple manners of implementing the environmental sensors of the present invention. One such implementation is described in the aforementioned U.S. Patent Application entitled “System and Method for Autonomous High-Speed Navigation”. The present invention may alternatively use a combination of LIDAR and radar scanners as disclosed in the above-identified application.

In the embodiment illustrated in FIGS. 1 and 2, rear vehicle 10c is a manned vehicle operating under autonomous control. Vehicle 10c, despite being positioned in the rear of the convoy, operates as a master vehicle while vehicles 10a, 10b operate as slave vehicles. As used herein, “master” refers to the single vehicle that sets the free convoy control parameters of the navigation strategy (e.g. speed and separation) and “slave” refers to those vehicles which respond to the master's convoy control parameter signals. In this preferred embodiment of the present invention, any of the vehicles 10a, 10b, 10c is adapted for operation as a master or slave vehicle. Prior to operation of the convoy, a pre-planned route is determined utilizing a process described below and, in more detail, in the above-identified application. The pre-planned route is communicated to the vehicles 10a, 10b, 10c in the form of GPS waypoints. The human operator of vehicle 10c sets convoy control parameters preferably including the speed and spacing of the vehicles and this information is communicated to vehicles 10a, 10b, 10c.

The lead vehicle 10a utilizes its environmental sensors to sense the environment ahead of it along the pre-planned route. The information from the environmental sensors is used by the lead vehicle 10a so that it can avoid sensed obstacles and center itself on the road by looking for lane markers and geometric cues. Additionally, each following vehicle 10b, 10c utilizes environmental sensors to provide information to correct its position laterally along the pre-planned route.

Each 10a, 10b, 10c is further equipped with a controller 28 having programmable software for controlling operation of the vehicle. The software includes a communications interface allowing the vehicle to transfer and receive information from the other vehicles through its radio communicator. The software stores the pre-planned route as well as the desired speed and spacing chosen by the human operator of master vehicle 10c. Additionally, it monitors the position of its vehicle as well as the other vehicles in the convoy and constantly adjusts the speed and steering to maintain the desired speed and spacing. It is important to maintain the desired spacing between vehicles in order to avoid collisions between the vehicles while keeping the vehicles close enough for radio communication. The controller receives information from its radar scanners, its GPS receiver and from the other vehicles to determine its current position. This information is exchanged between all vehicles over the radio communicators.

As mentioned above the master defines the parameters of the driving strategy. In the preferred embodiments the master defines the base speed of the convoy, As the vehicles drive, the lead vehicle will enter turns before the following vehicles (including, potentially, the master). In this case, the lead vehicle slows to safely negotiate the turn and the rest of the vehicles respond to either maintain a safe spacing between the vehicles, or to slow for the turn.

In order to accomplish these behaviors, in the preferred embodiment the vehicles transmit their location to the other vehicles. In the preferred embodiment, the master is autonomous with human supervision. The human supervision could be remote or in the driver seat depending on the need. The supervision could then set parameters of the convoy controls, such as speed and base separation, for the master to servo off of. The slave vehicles would in turn servo off of the master.

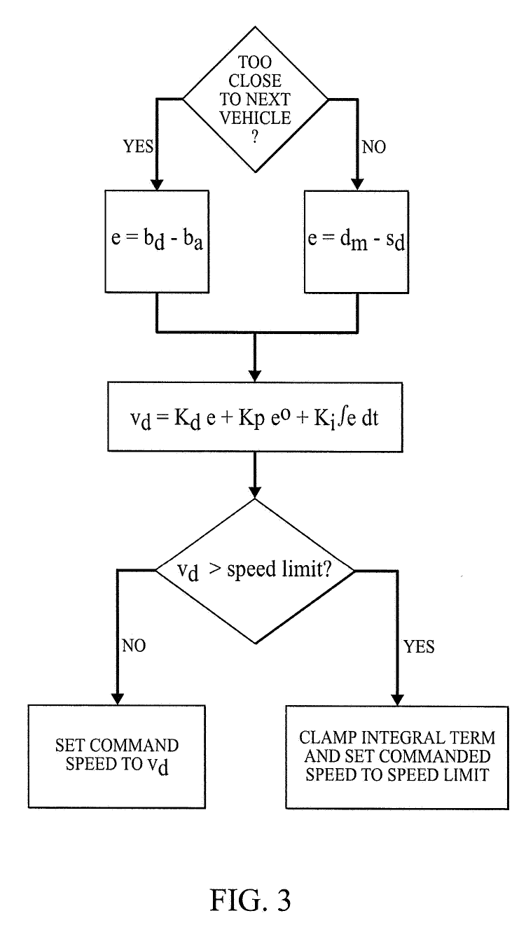

Before a route is executed, a base separation profile is set as s_{d}=f(v)+s₀ᵢ. Where f is a linear function of the current vehicle speed (v), and s₀ᵢ is the desired separation between the master vehicle and the i^{th} slave when the vehicles are stationary. While the vehicles are driving, they compute an actual separation , Sₐ, by integrating path length from themselves to the location of the master vehicle in the convoy. Nominally, the slave vehicles servo off of the separation distance the master vehicle and the slave vehicle. To prevent collision between the slave vehicles the slaves also compute a buffer distance, b_{d}, to the vehicle ahead of them in the convoy. If this distance is less than a threshold distance, the vehicle servos off of the buffer distance rather than the distance to the master. See FIG. 3.

The desired vehicle speed is controlled using a proportional-integral-derivative (PID) controller that servos desired velocity as a function of error in separation as defined above. When the speed suggested by the PID controller is greater than the speed limit, the PID controller integral term is clamped to avoid integrator runaway. See FIG. 3 wherein
e: Servo error fed into PID controller
b_{d}: desired buffer between slave and next vehicle
bₐ: actual buffer between slave and next vehicle
dₘ: distance between slave and master
s_{d}: desired separation between slave and master
v_{d}: desired velocity
K_{d}: derivative gain
Kₚ: proportional gain
Kᵢ: integral gain

As discussed above, the master vehicle can be selected to be any vehicle in the convoy. The lead vehicle in the first position navigates utilizing the navigation system of the present invention as is discussed below and in more detail in the above-identified application. In order to operate in a pre-planned route, pre-planned data are fused with information about the immediate environment of the autonomous vehicles obtained from the onboard environmental sensors to develop a detailed cost map of the vehicle's environment. The fused map is used to develop a new path for the vehicle that is then implemented while the vehicle is in the field.

The pre-planning portion of the navigation systems of the present invention creates a path, including its associated speeds and estimated elapsed time, prior to the robot traversing a route. As used herein, “route” refers to an area within the environment within which the robot will navigate and corresponds roughly to the roads selected from a map in planning a trip. In contrast, as used herein “path” refers to the specific points that the robot pass through or plans to pass through. For example, the “path” would then correspond to the specific lane or part of the road on which the robot travels. The preplanning system of the present invention preferably provides critical input that allows the navigation system to make assumptions about the environment to be navigated. The pre-planning system initially may be provided with a series of waypoints that define a route to be traversed by the robot. In presently preferred embodiments, the waypoints are provided as GPS coordinates. The pre-planning system is also preferably provided with any hard speed limits that are implemented as part of the course. A path is interpolated between waypoints.

Even though the pre-planned path is useful in predicting and enabling high-speed navigation, an autonomous vehicle will encounter circumstances in the field that cannot be anticipated by pre-planning. For example, obstacles may be encountered along the route, thus forcing the autonomous vehicle to deviate from the pre-planned path to avoid them. In addition, deviations in vehicle location or GPS tracking may result in the pre-planned path, being inappropriate. An autonomous vehicle will be forced to alter the specific path that is followed during the navigation itself through the information obtained about the local environment during travel. While this information is integral to the success of the autonomous vehicle, the pre-planned route nonetheless provides the autonomous vehicle with valuable information.

On a coarse level information regarding location of each vehicle is preferably obtained from GPS receiver located on the vehicle. In certain preferred embodiments, GPS-based information is used to ascertain the location of each vehicle with respect to the preplanned route and path.

Presently preferred embodiments of the present invention combine data from a variety of environmental sensors to perceive the world. After a path is determined by the conformal planner and a speed is selected by the human operator, those onboard commands are sent to the vehicle's steering and acceleration systems using drive-by-wire technology.

In one alternative embodiment, the master vehicle is also unmanned. The vehicle plays the same role, defining speeds for the entire convoy. In this case, the master vehicle might have additional, more expensive, sensing. In the case of an unmanned master, the master would serve as a speed setter. It is important to note that in the unmanned case, the entire convoy is essentially autonomous and that if the master is somehow compromised, the other vehicles could then redefine a master and continue on.

In an additional embodiment, the master vehicle is manned and under human control of both vehicle and convoy controls.

Those of skill in the art will recognize that numerous modifications of the above-described methods and apparatuses can be performed without departing from the present invention. For example, one of skill in the art will recognize that the apparatuses of the present invention may be implemented using farming equipment such as a convoy of an agricultural crop harvester vehicle in front and a crop collector vehicle bring up the rear. The human operator is positioned in the collector vehicle where he can easily monitor the production of the harvester vehicle without having to turn around. Like wise, in an earthmoving or construction environment, a human operator positioned at the rear of the convoy can easily monitor the operation of the vehicles ahead of it.

1. A system for controlling the navigation of a convoy of vehicles comprising:
a lead autonomous vehicle; and
at least one follower vehicle following the lead vehicle; wherein one of the at least one follower vehicle is a master vehicle, and the lead vehicle is a slave vehicle; and wherein the master vehicle sets at least one convoy control parameter.

2. The system of claim 1, wherein any follower vehicle of the at least one vehicle that is not the master vehicle is a slave vehicle.

3. The system of claim 2, wherein the at least one convoy control parameter set by the master vehicle is speed.

4. The system of claim 2, wherein the at least one convoy control parameter set by the master vehicle is vehicle spacing.

5. The system of claim l, wherein in each vehicle comprises:
a communicator for communicating with other vehicles;
at least one environmental sensor for sensing environmental conditions;
a global position satellite receiver;
an inertial measurement unit; and
a controller.

6. The system of claim 1, wherein each vehicle in the convoy is adapted for operating alternatively as a slave and a master vehicle.

7. The system of claim 1, wherein each vehicle in the convoy is adapted for operating alternatively as a lead and a follower vehicle.

8. The system of claim 1, wherein the master vehicle is operated autonomously.

9. The system of claim 1, wherein the master vehicle is operated autonomously under human supervision.

10. The system of claim 1, wherein the master vehicle is human-operated.

11. A method of controlling the navigation of a convoy of vehicles comprising:
providing an autonomous lead vehicle at the beginning of a convoy of autonomous vehicles;
providing at least one follower vehicle following the lead vehicle;
setting at least one convoy control parameter by a master vehicle that is one of the at least one follower vehicle; and
communicating the convoy control parameters from the master vehicle to the other vehicles.

12. The method of claim 11, wherein the at least one convoy control parameter set by the master vehicle is speed.

13. The method of claim 11, wherein the at least one convoy control parameter set by the master vehicle is vehicle spacing.

14. The method of claim 11, wherein each vehicle in the convoy is adapted for operating alternatively as a slave and a master vehicle.

15. The method of claim 11, wherein each vehicle in the convoy is adapted for operating alternatively as a lead and a follower vehicle.

16. The method of claim 11, wherein the master vehicle is operated autonomously.

17. The method of claim 11, wherein the master vehicle is operated autonomously under human supervision.
